(19) United States
(12) Patent Application Publication
(10) Pub. No.: US 2007/0033226 A1
(43) Pub. Date: Feb. 8, 2007

(54) Method for publishing academic articles

(75) Inventor: Teruto Ohta, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: The Chemical Society of Japan

(21) Appl. No.: 11/248,199

(22) Filed: Oct. 13, 2005

Related U.S. Application Data
(60) Provisional application No. 60/705,550, filed on Aug. 5, 2005.

(51) Int. Cl. G06F 17/00

(52) U.S. Cl. 707/104.1

(57) ABSTRACT

This method is related to the publication of academic articles to be accessed on the web. The current method is called the user-pay model, where articles are organized under the title of a journal, and readers can buy the license to access articles from the publisher. Another model, called the author-pay model, has been proposed and partially practiced, where an author pays the cost of publication online so that readers who are not subscribers can access the author's article free of charge. A new business model, which is patentable, is defined where an author pays for the cost of publication at first and readers pay a certain amount to access the author's article. The amount paid by readers to access an article is used to refund the author of their publication cost.

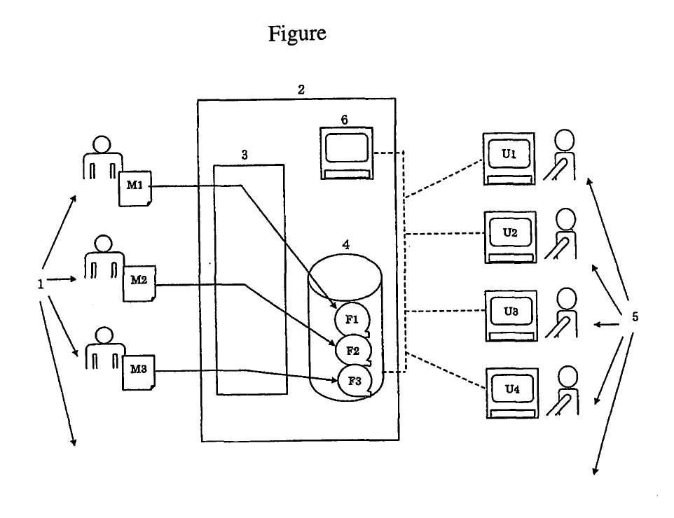

### CROSS REFERENCE TO RELATED APPLICATIONS

The present application claims the benefit of U.S. Provisional Application No. 60/705,550 filed Aug. 5, 2005, the disclosure of which is incorporated herein by reference.

### FIELD OF THE INVENTION

The present invention relates to the publication of academic articles through the internet.

### BACKGROUND OF THE INVENTION

Articles produced by researchers and scholars in various fields have been published in periodical journals. Manuscripts submitted to a publisher are checked for self-consistency and originality through peer-review by scholars of the same field. Then, the text is combined with illustrations and tables, if available, in a good design and are printed and published. Scholars and libraries used to make contracts with publishers to pay for subscriptions to journals they needed by title. Recently, many publishers have started to produce electronic versions of their journals and provide them together with printed versions. However, the style of the contract for electronic journals between the publishers and users remains basically the same with that of printed journals, that is, users pay for each title of journal for a certain period of time in advance in order to access the articles. The business model of publication, where readers of articles bear the major part of the publication cost as explained above, is called the user-pay-model.

A newer method, where the authors or funding organizations of the research bear the publication costs, has been proposed and is partly practiced. This came from the criticism that the result of research works funded by the government should be freely available to tax payers. Such a model is called the author-pay-model. The merit and demerit of the current models are well summarized in the reference.

Since the payment system is decided by the title of journals and cannot be changed article by article in either business model, it cannot be justified when considered from the rule the beneficent pays. In the user-pay-model, users have to pay for the publication of articles included in the same title that he or she may not have interest. If an article is related to a very specialized or new field, the author should not expect many readers. However, publishing such articles has never been considered to be less important. Such an article might be reviewed after 20 to 30 years and bring great acclaim upon the author. Regardless, at the point of publication, the beneficent is the author and there is no reason for other people to pay for the publication of such articles. On the other hand, articles that are related to a field that many other people are interested will have many readers and will contribute to their work. In this case, it is not conducive to the dissemination of presently important research to have the authors alone pay for the publication of such articles, as there are many beneficiaries.

### SUMMARY OF THE INVENTION

The invention provides a model by which the publication costs of articles that have high access rates are shared among readers, while those that have low access rates are paid mainly by authors.

In the new model, the authors bear the basic costs of publication. Publishers open the processed articles to the internet, ready for access from users with mechanisms to count and record the number of accesses from each user and charge a fee for usage in accordance with the number of access and/or download. The fee thus collected by the publisher is distributed to the authors in accordance with the number of accesses and/or downloads of each article. In this way, the publishing cost of articles with many readers is shared among readers and that of articles with few readers is mainly paid by authors.

### BRIEF DESCRIPTION OF THE DRAWING

The accompanying drawing illustrates an embodiment of the invention by way of example, and not by way of limitation. The drawing constitutes a part of the specification, and together with the description, explains the invention.

The FIGURE is a diagram depicting the concept of the invented business model.

### DETAILED DESCRIPTION OF THE INVENTION

The method to realize the new model will be explained in more detail along with the FIGURE. Author 1 sends manuscripts M1, M2, and M3 to the publisher 2. The publisher processes the manuscripts through peer-review and editions, and stores the corresponding finalized articles F1, F2, and F3 on the server 4. The server is accessible from terminals U1, U2 and U3 through the internet and each access is monitored and recorded by the monitor 6. Publishers process the manuscripts, while being funded by the authors. Users have to make a contract with the publisher in advance to obtain the right to access the articles. The publisher charges the users the amount at a rate pre-determined as a function of the number of accesses and/or downloads, and then distributes the income to the authors in accordance with the number of accesses and/or downloads of each authors' articles. An author in this way can recover at least a part of the publishing cost they paid upon submission of their manuscript with regards to the popularity of their article.

In general, manuscripts are subjected to peer-review and are not always published. Therefore, it is possible and more reasonable to make a rule that the authors pay for the peer reviewing process upon submission and pay for the publication after the acceptance of their manuscript is determined. Authors should not necessarily cover 100% of the publication cost and the purpose of this invention will be fulfilled if the cover a part of the cost. The users can pay for each access to articles, but it is more reasonable to make an arrangement between the publishers and libraries in which an IP address is assigned to each library or institution and upon each access by users, the IP address is referred. The payment should be done after a certain period of time for each library.

Publishers can place a reasonable margin to the submission fee and/or the access fee to secure profit. The refund of the access fee to the author can be done within the limit of the submission fee or can refund above it to create more incentive to authors.

What is claimed is:

1. A method of business in which a publisher publishes an article on the internet, the method comprising of:
monitoring and recording the number of accesses and/or downloads to each article by each user;
charging each user an access fee in accordance with the amount of usage;
in cases where the author and publisher have different affiliations, charging a submission fee to the author; and
paying part of the usage fee to the authors in accordance with the amount of usage of their article.
